(19) United States
(12) Patent Application Publication
(10) Pub. No.: US 2023/0384448 A1
(43) Pub. Date: Nov. 30, 2023

(54) METHODS AND SYSTEMS FOR OPERATING LIDAR SYSTEMS

(71) Applicant: SHENZHEN ADAPS PHOTONICS TECHNOLOGY CO., LTD., Shenzhen (CN)

(72) Inventors: Junzhong XIE, Shenzhen (CN); Chao ZHANG, Shenzhen (CN)

(21) Appl. No.: 18/323,207

(22) Filed: May 24, 2023

(30) Foreign Application Priority Data
May 24, 2022 (CN) 202210575195.7

(51) Int. Cl. G01S 17/10; G01S 7/484

(52) U.S. Cl. CPC G01S 17/10; G01S 7/484

(57) ABSTRACT

According to an embodiment, the present invention provides a LiDAR system that improves target object distance detection by mitigating internal reflections and glare artifacts. The system includes a laser source, an optical module, a pixel circuit, a time-to-digital converter (TDC), a memory device, and a processor module. The processor module uses two data arrays to determine two vectors and utilizes a similarity function, such as the Pearson correlation coefficient, to identify and remove artifact peaks from the data. These artifact peaks may be associated with glare, semi-transparent objects, or internal reflections within lens elements. There are other embodiments as well.

### CROSS-REFERENCES TO RELATED APPLICATIONS

The present application claims priority to Chinese Patent Application No. 202210575195.7, filed May 24, 2022, which is common own and incorporated by reference herein for all purposes.

### BACKGROUND OF THE INVENTION

LiDAR (Light Detection and Ranging) is a technology that calculates the distance to objects by measuring the time it takes for light beams to travel in space. Owing to its high accuracy and extensive measurement range, LiDAR has found widespread applications in fields such as consumer electronics, autonomous driving, remote sensing, and augmented/virtual reality (AR/VR).

In LiDAR-based distance measurements, single-photon avalanche diodes (SPADs) are frequently utilized to receive the returning light signals. The measurement process relies on the Time-Correlated Single Photon Counting (TCSPC) method, a direct time-of-flight (dTOF) technique, to accurately determine distances.

Although existing LiDAR technology has made significant advancements, there are still limitations and challenges that need to be addressed to enhance its performance and expand its applications.

### BRIEF SUMMARY OF THE INVENTION

According to an embodiment, the present invention provides a LiDAR system that improves target object distance detection by mitigating internal reflections and glare artifacts. The system includes a laser source, an optical module, a pixel circuit, a time-to-digital converter (TDC), a memory device, and a processor module. The processor module uses two data arrays to determine two vectors and utilizes a similarity function, such as the Pearson correlation coefficient, to identify and remove artifact peaks from the data. These artifact peaks may be associated with glare, semi-transparent objects, or internal reflections within lens elements. There are other embodiments as well.

An embodiment of the present invention proposes a LiDAR system featuring multiple components. The laser source in this system is designed to generate a pulsed laser at a designated initial time, which is characterized by a distinct first pulse width. Additionally, an optical module within the system is configured to receive reflected laser signals. The system also houses a pixel circuit, designed to convert these reflected laser signals into electrical outputs, with the circuit accommodating ‘m’ pixels. This system also includes a Time-to-Digital Converter (TDC) structured to create ‘m’ histogram data corresponding to the ‘m’ pixels. Each histogram data comprises ‘n’ intensity values that align with ‘n’ time bins. A memory device is integrated within the system to store this histogram data. Lastly, a processor module within this system is constructed to perform a range of tasks: It generates a first data array with ‘m’ values, each value being a function of a sum of corresponding ‘n’ time bin values, corresponding to the ‘m’ pixels. It also formulates a second data array containing ‘m’ entries, each entry corresponding to the ‘m’ pixels and embodying one or more total peak values. Utilizing these data arrays, the processor module then establishes a first vector and a second vector. By employing a similarity function, the processor module can eliminate one or more artifact peaks from the second data array. Utilizing at least the second data array, the processor module is able to determine the distance to the target object.

Implementations may incorporate one or more of the following enhancements. In the LiDAR system, the processor module may be further engineered to pinpoint a preliminary peak location utilizing at least the second data array. It may also be programmed to calculate a Time of Flight (ToF) value, leveraging the first time and a secondary time, with the latter based on the identified preliminary peak location. The pixel circuit might be equipped with a SPAD sensor array. The optical module of the LiDAR system may consist of multiple lens elements, with artifact peaks possibly linked to internal reflections arising from these lens elements. Artifact peaks could also be associated with glare from a secondary light source or with a semi-transparent object. The processor module can be further designed to calculate a Pearson correlation coefficient using at least the first and second data arrays, with artifact peaks often corresponding to low similarity values. Implementations of these techniques may encompass hardware, a method or process, or computer software on a computer-accessible medium.

One general embodiment provides a LiDAR system that includes a laser source designed to produce a pulsed laser at a specified initial moment, the pulsed laser being defined by a first pulse width. This system also includes an optical module tailored to receive a reflected laser signal. Furthermore, the system includes a pixel circuit engineered to generate electrical outputs based on the reflected laser signal, comprising m pixels. Also present is a Time-to-Digital Converter (TDC), designed to create m histogram data corresponding to m pixels, each histogram data consisting of n intensity values linked to n time bins. A memory device is incorporated to store the histogram data. Additionally, the system includes a processor module purposed to: identify 1 histograms from the m histogram data, potentially including a first and a second histogram; discern a first peak from the first histogram at a first bin location; detect a second peak from the second histogram at a second bin location aligned with the first bin location; calculate a ratio between a first intensity of the first peak and a second intensity of the second peak; decide if the second peak is an artifact peak based on the ratio; and establish a target object distance employing at least the first peak.

Specific implementations may incorporate one or more of the following characteristics. The system may associate the artifact peak with a glare produced by a secondary light source. The processor module might be further configured to eliminate the second peak. It could also be devised to identify and remove a third peak. The first histogram might be linked to a first SPAD pixel, and the second histogram to a second SPAD pixel. The realization of these techniques can be in the form of hardware, a method or process, or computer software on a computer-accessible medium.

Another general embodiment provides a LiDAR system that includes a laser source tailored to generate a pulsed laser at a specified initial moment, defined by a first pulse width. This system also includes a control module purposed to process the initial moment. It also incorporates an optical module designed to receive a reflected laser signal. Moreover, the system includes a pixel circuit intended to produce electrical outputs based on the reflected laser signal, possibly encompassing m pixels. Also included is a Time-to-Digital Converter (TDC) configured to produce m histogram data corresponding to m pixels, each histogram data consisting of n intensity values aligned with n time bins. A memory device is present for storing the histogram data. Further, the system includes a processor module devised to: generate a first data array potentially comprising m values corresponding to the m pixels, each of the m values being a function of a sum corresponding to n time bin values; produce a second data array that might consist of m entries corresponding to the m pixels, each entry possibly encompassing one or more total peak values; establish a first vector using the first data array; form a second vector using the second data array; and identify a first peak from the second data array utilizing a similarity function.

Certain implementations may encompass one or more of the following characteristics. The system may associate the first peak with a glare artifact. It could also include an optical splitter designed to direct a portion of the pulsed laser to the control module. The processor module could be further programmed to calculate similarity coefficients using the similarity function. Additionally, it could be designed to compute a second moment based on a second peak selected utilizing at least the second data array. The processor module could also be further engineered to determine a distance based on a discrepancy between the initial and the second moments. The realization of these techniques can be in the form of hardware, a method or process, or computer software on a computer-accessible medium.

It is to be appreciated that embodiments of the present invention provide many advantages over conventional techniques. By identifying and removing artifact peaks associated with glare, semi-transparent objects, and internal reflections within lens elements, this LiDAR system greatly improves the accuracy of distance detection. This ensures more precise and reliable measurements, even in challenging environments. The innovative use of a similarity function, such as the Pearson correlation coefficient, to process and filter data allows for more effective identification and mitigation of optical artifacts. This contributes to overall better performance of the system, enhancing its reliability and functionality. The ability of the system to handle various types of optical interference makes it highly versatile. It is designed to effectively operate in diverse scenarios and conditions, making it suitable for a wide range of applications—from autonomous vehicles to environmental sensing and mapping. For applications like autonomous vehicles, the ability to accurately measure distances despite glare and other optical interferences significantly improves safety, as it reduces the risk of misjudgments or collisions. The system's use of two data arrays and vectors for processing the histogram data derived from the TDC allows for more efficient data handling, contributing to faster processing times and lower computational load.

The present invention achieves these benefits and others in the context of known technology. However, a further understanding of the nature and advantages of the present invention may be realized by reference to the latter portions of the specification and attached drawings.

### BRIEF DESCRIPTION OF THE DRAWINGS

FIG. 1 is a simplified flow diagram illustrating an exemplary process of processing LiDAR signals according to embodiments of the present invention.

FIG. 2 is a simplified diagram illustrating a system for processing LiDAR signals according to embodiments of the present invention.

FIG. 3 is a simplified block diagram illustrating a LiDAR system 300 according to embodiments of the present invention.

FIG. 4 is a simplified diagram illustrating LiDAR system 300 affected by glare.

### DETAILED DESCRIPTION OF THE INVENTION

According to an embodiment, the present invention provides a LiDAR system that improves target object distance detection by mitigating internal reflections and glare artifacts. The system includes a laser source, an optical module, a pixel circuit, a time-to-digital converter (TDC), a memory device, and a processor module. The processor module uses two data arrays to determine two vectors and utilizes a similarity function, such as the Pearson correlation coefficient, to identify and remove artifact peaks from the data. These artifact peaks may be associated with glare, semi-transparent objects, or internal reflections within lens elements. There are other embodiments as well.

During the LiDAR measurement process, a histogram needs to be formed, followed by signal processing to obtain target information. However, interference factors such as glare and reflections within the module and cover plate can cause multiple peaks in the histogram for some pixels. In single-peak cases, the common approach is to select the peak with the highest signal-to-noise ratio to extract distance information. However, in multi-peak cases where the target peak has a weak signal-to-noise ratio, this can result in distance perception errors and measurement inaccuracies.

In existing technology, when LiDAR distance measurements encounter multiple peaks in the received photon signals, image filtering is employed. However, the filtering effect is often poor, resulting in a higher likelihood of distance calculation errors and significant measurement inaccuracies.

Therefore, there is room for improvement and development in the existing technology. According to various embodiments, the present invention provides a LiDAR distance measurement method and system that effectively reduces glare. An objective is to tackle the issue of inadequate filtering effects and substantial measurement inaccuracies in the current technology when utilizing image filtering in scenarios where multiple peaks are present in the received photon signals during LiDAR distance measurements. By addressing these shortcomings, embodiments of the present invention improve the overall performance and reliability of LiDAR systems.

While the above is a full description of the specific embodiments, various modifications, alternative constructions and equivalents may be used. Therefore, the above description and illustrations should not be taken as limiting the scope of the present invention which is defined by the appended claims.

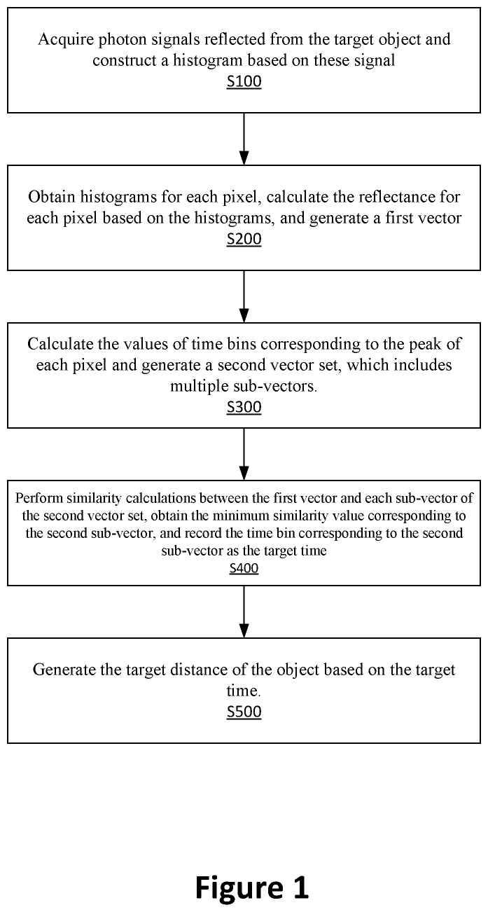

In a specific embodiment, the present invention provides a LiDAR distance measurement method to reduce glare. Please refer to FIG. 1, which provides a flowchart of the preferred embodiment for this method. As depicted in FIG. 1, the method includes:

Step S100: Acquire photon signals reflected from the target object and construct a histogram based on these signals.

Step S200: Obtain histograms for each pixel, calculate the reflectance for each pixel based on the histograms, and generate a first vector.

Step S300: Calculate the values of time bins corresponding to the peak of each pixel and generate a second vector set, which includes multiple sub-vectors.

Step S400: Perform similarity calculations between the first vector and each sub-vector of the second vector set, obtain the minimum similarity value corresponding to the second sub-vector, and record the time bin corresponding to the second sub-vector as the target time.

Step S500: Generate the target distance of the object based on the target time.

In particular implementations, a LiDAR operating method of this invention can effectively address the multi-peak phenomenon that occurs when several target reflection signals are received on the same pixel but follow different ray paths. These target reflection signals may result from multiple internal reflections within the lens. By addressing this issue, the proposed method aims to enhance the overall performance and accuracy of LiDAR systems in challenging situations.

An embodiment of this invention relies on a direct time-of-flight measurement method for distance estimation. The laser emission module may include, but is not limited to, one of the following: EEL, VCSEL, or picosecond laser. A SPAD serves as the receiving module, with EEL referring to edge-emitting laser, which emits light that travels parallel to the substrate surface, and VCSEL denoting vertical-cavity surface-emitting laser, which emits light in a direction perpendicular to the substrate surface. The SPAD array operates in Geiger mode, enabling it, in theory, to achieve single-photon detection with the highest possible sensitivity.

The emission module directs a pulsed laser towards the target object and acquires photon signals reflected from the target object using the receiving module. A histogram is constructed based on these photon signals. In LiDAR systems, a histogram is a graphical representation used to analyze and process the collected photon signals. It displays the distribution of photon counts over discrete time bins, providing insight into the signal characteristics and aiding in distance measurement calculations. When a LiDAR system emits a laser pulse towards a target object, the light reflects off the object and returns to the LiDAR's receiving module. The time it takes for the light to travel to the object and back, known as the time-of-flight, is proportional to the distance between the LiDAR system and the target object. The receiving module, often using SPADs, detects these returning photons and records their arrival times. The histogram is constructed by dividing the time-of-flight data into discrete time bins, and then counting the number of photon detections within each bin. The resulting histogram displays the photon count distribution as a function of time. In LiDAR distance measurements, the highest peak in the histogram generally corresponds to the most likely true distance between the LiDAR system and the target object. However, as explained above, histograms can also contain multiple peaks due to various factors such as noise, reflections, or glare. By analyzing the histogram, LiDAR systems can differentiate between these peaks and more accurately determine the target object's distance.

Regardless of the number of glare interferences, the change in intensity reflectance values before and after the interference is minimal. As a result, the intensity values can serve as a reference for comparison. Bins close to the intensity value represent signal peaks, while bins with significant differences from the intensity value are caused by glare and should be eliminated.

Different pixels correspond to different histograms. The histogram for each pixel is obtained, the reflectance for each pixel is calculated based on the histogram, and a first vector is generated: Obtain the values of time bins corresponding to the peak of each pixel and generate a second vector set, which includes multiple sub-vectors with the same vector dimensions as the first vector; calculate the similarity between each sub-vector in the second vector set and the first vector, obtain the second sub-vector with the minimum similarity value, record the time bin corresponding to the second sub-vector as the target time, and calculate the target distance of the object based on the target time.

By comparing the distribution trends of elements within the two vectors, such as the first vector x (I1, . . . , I21) and the second vector y1 (T1, . . . , T21), . . . , y64 (T1, . . . , T21), although x represents reflectance values and y represents bin values, the similarity formula can be used to compare the internal distribution of x and y. A minimum similarity value between x and y indicates consistency in their distribution. One of the 64 y values is chosen as the target time.

Let the target distance be d and the value of the time bin with the minimum similarity be t; then, d=ct/2, where c is the speed of light, typically denoted as 3*10\hat{ }8 m/s.

In a specific embodiment, obtaining a histogram for each pixel, calculating the reflectance for each pixel based on the histogram, and generating the first vector includes: Obtaining the histogram corresponding to each pixel's SPAD within the illuminated area, where the histogram is noise-free; and

Accumulating the photon count of each pixel's histogram to obtain the corresponding reflectance and generating the first vector.

In specific implementations, the intensity method is used within the illuminated area to address the multi-peak problem, specifically as follows: Calculate the reflectance using the histogram distribution of each pixel in the illuminated area, where:

intensity(x,y)=sum(hist(x,y))−sum(noise(x,y)).

This results in obtaining the noise-free histogram corresponding to each pixel's SPAD within the illuminated area. Accumulate the photon count of each pixel's histogram to obtain the corresponding reflectance and generate the first vector.

In an embodiment, calculating the values of time bins corresponding to the peak of each pixel and generating the second vector set, which includes multiple sub-vectors, involves:

Analyzing each histogram to obtain all pixel data, which includes m single-peak pixels and n multi-peak pixels, with each multi-peak pixel corresponding to at least two time bin values; and

Calculating the values of time bins corresponding to the peak of each pixel and generating the second vector set, which includes at least 2ⁿ sub-vector sets, with each sub-vector set containing the values of time bins corresponding to the peak of all pixels.

In specific implementations, after performing pixel filtering operations on each histogram, obtain all pixel data, which includes both multi-peak and single-peak data, such as m single-peak pixels and n multi-peak pixels. Each multi-peak pixel corresponds to at least two time bin values, and record the coordinates of the single-peak pixels and the coordinates of the multi-peak pixels.

Calculate the values of time bins corresponding to the peak of each pixel and generate the second vector set, which includes at least 2ⁿ sub-vector sets, with each sub-vector set containing the values of time bins corresponding to the peak of all pixels. The sub-vectors in the second vector have the same vector dimensions as the first vector.

In an embodiment, the positions of the internal elements in the first vector correspond one-to-one with the positions of the internal elements in each subvector of the second vector set.

In a specific implementation, to calculate the similarity between the first vector and each subvector in the second vector set, it is important to ensure that the positions of the internal elements in the first vector correspond one-to-one with the positions of the internal elements in each subvector of the second vector set, to accurately find the time bin with the smallest similarity value.

In an embodiment, after calculating the time bin values corresponding to the peak value of each pixel and generating the second vector set containing multiple subvectors, the method further includes:

Acquiring predefined zones, performing exposure according to the predefined zones, and calculating the similarity between the first vector and each subvector in the second vector set within each zone; and

Obtaining the subvector corresponding to the smallest similarity value, and marking the time bin corresponding to the second subvector as the target time for each zone.

In a specific implementation, using zone-based exposure and reception can effectively reduce the problems of multipath effects both outside and inside the lens. Therefore, a predefined exposure area method can be used to address glare issues.

The predefined exposure area is referred to as the predefined zone. After acquiring the predefined zones, perform exposure within the predefined zones, and receive the histogram of the photon signals returned by each pixel within the zone.

Calculate the similarity between the first vector and each subvector in the second vector set within each zone, obtain the subvector corresponding to the smallest similarity value, and mark the time bin corresponding to the second subvector as the target time for each zone.

Taking zone-based exposure as an example, calculate the intensity of all SPADs in the zone, such as 21 pixel SPADs in the zone; calculate the intensity of 21 pixels, as shown in Table 1 below:

TABLE 1

| | | | | | | |
|---|---|---|---|---|---|---|
| I1 | I2 | I3 | I4 | I5 | I6 | I7 |
| I8 | I9 | I10 | I11 | I12 | I13 | I14 |
| I15 | I16 | I17 | I18 | I19 | I20 | I21 |

As can be seen from Table 1, Intensity calculation=the sum of all count numbers in the entire histogram (noise already removed); obtain the count number from the histogram of each SPAD, even if there are double peaks, add all count values of the double peaks. Calculate the bin values of 21 pixels, as shown in Table 2 below:

TABLE 2

| | | | | | | |
|---|---|---|---|---|---|---|
| T1 | T2 (a2, b2) | T3 | T4 | T5 (a5, b5) | T6 | T7 |
| T8 (a8, b8) | T9 (a9, b9) | T10 | T11 | T12 | T13 (a13, b13) | T14 |
| T15 | T16 | T17 | T18 (a18, b18) | T19 | T20 | T21 |

From Table 2, identify the single-peak pixels such as T1, T4, T7, etc., totaling 15, and obtain the bin value of each peak. Find multi-peak pixels such as T2, T8, T9, etc., totaling 6, and obtain the bin value of each peak. From the multi-peak pixels, you can get the bin value of each single peak, i.e., (a2_bin, W2), (b2_bin, W2), where W2 refers to the position of the SPAD unit. In the multi-peak pixels, there are at least two single peaks, but it is unclear which single peak is needed and which single peak is caused by the flare phenomenon. Obtain the bin value corresponding to each peak from the histogram of each pad.

Calculate the similarity value, with the results shown in Table 3. In the calculation process, consider the entirety of Table 1 as a vector X, denoted as the first vector, and consider the entirety of Table 2 as a vector Y, denoted as the second vector set.

However, the choice of two peaks in the double-peak case will cause the vector Y to change. If there are 6 SPADs in Table 2 with double peaks, then the 21 SPAD vectors may generate 64 Ys, i.e., Y1 . . . Y64.

Substitute (X, Y1), (X, Y2) . . . (X, Y64) into formula F, calculate the similarity values, and obtain 64 Fs, i.e., F1, F2, . . . F64. The smaller the F value, the more similar they are, so choose the smallest value. If F5 is the smallest, then the bin of vector Y5 corresponding to F5 is the flight time used to calculate the distance.

In the end, retain the combination bin corresponding to Y5, as shown in Table 3.

TABLE 3

| | | | | | | |
|---|---|---|---|---|---|---|
| T1 | T2 (a2) | T3 | T4 | T5 (b5) | T6 | T7 |
| T8 (a8) | T9 (a9) | T10 | T11 | T12 | T13 (b13) | T14 |
| T15 | T16 | T17 | T18 (b18) | T19 | T20 | T21 |

As can be seen from Table 3, one peak has been removed from the double peaks, and the remaining peak value corresponds to the target time.

In an embodiment, calculate the similarity between the first vector and each sub-vector of the second vector set, including: Calculate the similarity between the first vector and each sub-vector of the second vector set based on a preset similarity formula, which can be the cosine distance formula or the Pearson correlation coefficient formula.

Specifically, during implementation, when calculating the similarity between the first vector and each sub-vector of the second vector set, you can use the cosine distance formula or the Pearson correlation coefficient formula. When using the cosine distance formula, the cosine value of the angle between two vectors in a vector space is used to measure the difference between two individuals. If the cosine value is close to 1 and the angle tends to 0, it means the two vectors are more similar. If the cosine value is close to 0 and the angle tends to 90 degrees, it means the two vectors are more dissimilar.

The Pearson correlation coefficient formula first calculates the covariance of the XY variables in the numerator and then calculates the standard deviation of X and Y in the denominator to obtain the Pearson correlation coefficient. For example, the Pearson correlation coefficient, often represented as “r”, is a statistical measure that calculates the linear relationship between two variables or datasets. It ranges from −1 to 1, where −1 indicates a perfect negative linear correlation, 1 indicates a perfect positive linear correlation, and 0 indicates no linear correlation between the two variables. In the context of the present disclosure, the Pearson correlation coefficient is used to evaluate the similarity between two histograms generated by LiDAR distance measurements. Specifically, it measures the correlation between intensity values in the histograms, which helps in identifying and filtering out the effects of glare and other interference.

It should be noted that there is not necessarily a fixed order between the steps mentioned above. Those skilled in the art can understand, based on the description of the embodiments of the present invention, that in different embodiments, the steps may have different execution orders, i.e., they can be executed in parallel, swapped, and so on.

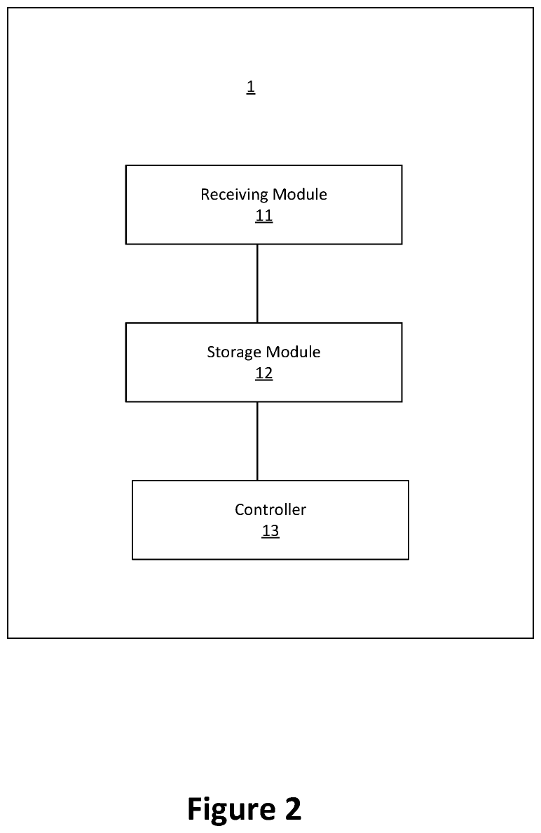

Another embodiment of the present invention provides a laser rangefinder chip for reducing glare, as shown in FIG. 2. The chip 1 includes:

A receiving module 11 for acquiring photon signals reflected by the target object;

A storage module 12 for constructing a histogram based on the photon signals; and

A controller 13 for obtaining the histogram of each pixel, calculating the reflectivity of each pixel based on the histogram, generating the first vector, calculating the values of the time bins corresponding to the peak of each pixel, and generating the second vector set, which includes multiple sub-vectors. The similarity between the first vector and each sub-vector of the second vector set is calculated, and the second sub-vector corresponding to the smallest similarity value is obtained. The time bin corresponding to the second sub-vector is recorded as the target time. The target distance of the object is generated based on the target time.

In a specific implementation, the receiving module acquires the photon signals reflected by the target object, and the storage module constructs a histogram based on the photon signals.

The controller obtains the histogram of each pixel and calculates the reflectivity of each pixel based on the histogram to generate the first vector;

Obtain the values of the time bins corresponding to the peak of each pixel, and generate the second vector set with the values of the time bins corresponding to the peak of each pixel. The second vector set contains multiple sub-vectors, each of which has the same vector dimension as the first vector; and

Obtain each sub-vector from the second vector set, calculate the similarity between each sub-vector and the first vector separately, obtain the second sub-vector corresponding to the smallest similarity value, record the time bin corresponding to the second sub-vector as the target time, and calculate the target distance of the object based on the target time.

By comparing the distribution trends of the internal elements of two vectors, for example, the first vector is x(I1, . . . I21), and the second vector is y1(T1, . . . T21) . . . y64(T1, . . . T21). Although x represents reflectance values and y represents bin values, their distributions can be compared using a similarity formula. When the distributions are consistent, the similarity value between x and y is minimized. One of the 64 y values is selected as the target time.

The target distance is denoted as d, and the value of the time bin with the minimum similarity is denoted as t. Then d=ct/2, where c is the speed of light, typically recorded as 3*10\hat{ }8 m/s.

In an embodiment, the controller is configured used for:
Obtaining the histogram corresponding to each pixel's SPAD in the illuminated area, which is the histogram after noise removal; and
Accumulating the photon count of each pixel's histogram to obtain the reflectance corresponding to each pixel, generating the first vector.

In practice, the intensity method is used within the illuminated area to address multi-peak problems, as follows: calculating reflectance using the hist distribution of each pixel in the illuminated area:

intensity(x,y)=sum(hist(x,y))−sum(noise(x,y)).

This results in obtaining the histogram corresponding to each pixel's SPAD in the illuminated area, which is the histogram after noise removal. Accumulating the photon count of each pixel's histogram to obtain the reflectance corresponding to each pixel, generating the first vector.

In an embodiment, the main controller is also configured for:

Analyzing each histogram to obtain all pixel data, including m single-peak pixels and n multi-peak pixels, where each multi-peak pixel corresponds to at least two time bin values; and

Calculating the time bin values corresponding to the peak of each pixel to generate the second vector set, which includes at least 2ⁿ sub-vector sets, each containing the time bin values corresponding to the peaks of all pixels.

In an implementation, after performing pixel filtering on each histogram, a complete set of pixel data is obtained. This set includes data from both single-peak and multi-peak pixels. For instance, the entire pixel data comprises ‘m’ single-peak pixels and ‘n’ multi-peak pixels, with each multi-peak pixel correlating to at least two time bin values. The coordinates for both single-peak and multi-peak pixels are recorded.

Subsequently, the time bin values associated with the peak of each pixel are calculated, generating a second set of vectors. This set comprises at least 2n sub-vector sets, each containing time bin values corresponding to the peaks across all pixels. The dimensions of these sub-vectors in the second vector set mirror those of the first vector set.

In one embodiment, there exists a one-to-one correspondence between the positions of internal elements within the first vector and those within each sub-vector in the second vector set.

In an implementation, to calculate the similarity between the first vector and each sub-vector within the second vector set and to prevent discrepancies in the distribution relationship, it is vital to maintain the one-to-one correspondence between the positions of internal elements within the first vector and those of each sub-vector in the second vector set. This correspondence ensures precise identification of the time bin exhibiting the least similarity.

Another embodiment of the invention provides an electronic device, which includes one or more processors and memory. Taking one processor as an example, the processor and memory can be connected through a bus or other means.

The processor is used for completing various control logic of the electronic device, which can be a general processor, digital signal processor (DSP), application-specific integrated circuit (ASIC), field-programmable gate array (FPGA), microcontroller, ARM (Acorn RISC Machine) or other programmable logic devices, discrete gates or transistor logic, discrete hardware controls, or any combination of these components. Moreover, the processor can also be any conventional processor, microprocessor, or state machine. The processor can also be implemented as a combination of computing devices, such as a combination of DSP and microprocessor, multiple microprocessors, one or more microprocessors combined with a DSP core, or any other such configuration.

The memory serves as a non-volatile computer-readable storage medium, which can be used to store non-volatile software programs, non-volatile computer-executable programs, and modules, such as program instructions corresponding to the glare reduction laser rangefinding method in the embodiments of the invention. The processor executes various functional applications and data processing of the device by running the non-volatile software programs, instructions, and units stored in the memory, thereby implementing the glare reduction laser rangefinding method in the method embodiments mentioned above.

The memory may include a program storage area and a data storage area, wherein the program storage area can store application programs required for operating the chip and at least one function; the data storage area can store data created based on the use of the device, etc. In addition, the memory may include high-speed random access memory and may also include non-volatile memory, such as at least one magnetic disk storage device, flash memory device, or other non-volatile solid-state storage devices. In some embodiments, the memory may optionally include remote memory relative to the processor, which can be connected to the device through a network. Examples of the aforementioned networks include but are not limited to the Internet, intranets, local area networks, mobile communication networks, and their combinations.

One or more units are stored in the memory, and when executed by one or more processors, the glare reduction laser rangefinding method in any of the method embodiments described above is performed, for example, executing the method steps S100 to S600 shown in FIG. 1 described above.

An embodiment of the invention provides a non-volatile computer-readable storage medium, which stores computer-executable instructions that, when executed by one or more processors, perform the method steps S100 to S600 shown in FIG. 1 described above.

As an example, non-volatile storage media can include read-only memory (ROM), programmable ROM (PROM), electrically programmable ROM (EPROM), electrically erasable ROM (EEPROM), or flash memory. Volatile memory can include random access memory (RAM) as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The disclosed memory controls or memory of the operating environment described herein are intended to include one or more of these and/or any other suitable types of memory.

Another embodiment of the invention provides a computer program product, which includes a computer program stored on a non-volatile computer-readable storage medium. This computer program comprises program instructions that, when executed by a processor, cause the processor to perform the method of reducing glare in laser ranging as described in the aforementioned embodiments. For example, executing the method steps S100 to S600 as described in FIG. 1.

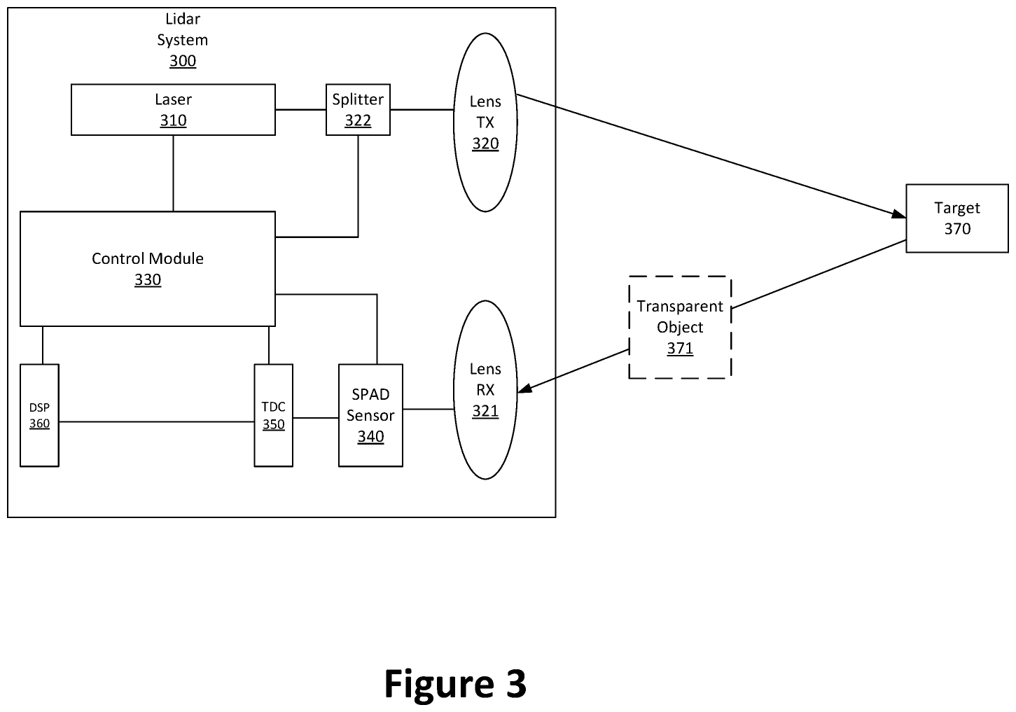

FIG. 3 is a simplified block diagram illustrating lidar system 300 according to embodiments of the present invention. This diagram is merely an example, which should not unduly limit the scope of the claims. One of ordinary skill in the art would recognize many variations, alternatives, and modifications. In principle, lidar system 300 measures distance by calculating the time differences between transmitted light signals and the corresponding received signals. Laser 310, as controlled by the control module 330, emits laser pulses at predefined intervals. As example, laser 310 may include stacked laser diodes that emit diffracted laser beams. Depending on the application, the output of laser 310 may be pulsed infrared laser signals. The laser pulse profile (e.g., width, shape, intensity, etc.) and the predefined intervals depend largely on the lidar system implementation and specifications, such as power, distance, resolution, and others.

Lidar system 300 is configured to reconstruct images, with distance information, using a SPAD array that includes many SPAD pixels. For this application, the output of the laser 310 is manipulated to create a predefined pattern. It is understood that lens 320 refers to an optical module that may include multiple optical and/or mechanical elements. In certain implementations, lens 320 includes diffractive optical elements to create a desired output optical pattern. Lens 320 may include focusing and optical correction elements, configured in multiple lens elements.

Control module 330 manages operations and various aspects of lidar system 300. As shown, control module 330 is coupled to laser 310 and splitter 322, along with other components. Depending on the embodiment, control module 330 can be implemented using one or more microprocessors. For example, control module 330 may include a microprocessor that can be used for timing control of input and output and power control of laser 310. Components such as TDC 350 and digital signal processor (DSP) 360 as shown are functional blocks that are—on the chip layer—implemented with the same processor(s) for the control module 330. In addition to providing control signal signals to laser 310, control module 330 also receives the output of the laser 310 via splitter 322. Based on the output of splitter 322, control module 330 activates SPAD sensor 340, TDC 350, and other components to process received signals. Additionally, the output of splitter 322 provides the timing of the outgoing light signal, and this timing information is later used in ToF calculations.

Laser 410, in various embodiments, is configured to emit infrared light with a wavelength of 800 nm to 950 nm, where the data processing device of this application has good detection performance for peaks with a wavelength of 905 nm. It is understood that in other embodiments, the laser 310 can also emit infrared light with a wavelength of 1550 nm, which is not specifically limited here.

The transmitted laser signal, upon reaching target 370, is reflected. For example, the shape of and size of target 370 could affect the subsequent reflected laser signal, where the medium between the target object 370 and the lidar system 300 may include air and dust, which may also affect the reflected laser signal. Transparent object 371 (or a semitransparent object) may be positioned between target 370 and lens 321, and contribute to undesired range calculation. The reflected laser signal is received by lens 321, which focuses the received laser signal onto SPAD sensor 340. Lens 321 may include multiple optical and mechanical elements. The transmission efficiency of lens 321 and reflection characteristics may affect the quality and quantity of light reception. For example, lens 321 may include an anti-reflective coating to address the glare problem caused by fully exposed or dispersed light source locations.

The quality of the input signal processed by the SPAD sensor 340 is intrinsically linked to the properties of lens 321. For instance, the transmission efficiency of lens 321 plays a significant role in determining the volume of light received. Moreover, its reflection characteristics greatly affect the quality of this received light, making these attributes critical for the effective functioning of the LiDAR system. Glare, an unwelcome consequence of internal reflections within lens 321, can obstruct the accuracy and precision of LiDAR measurements, often resulting in notable inaccuracies. By employing an anti-reflective coating on lens 321 or implementing other optical features, one can counteract the glare stemming from fully exposed or widely dispersed light source locations.

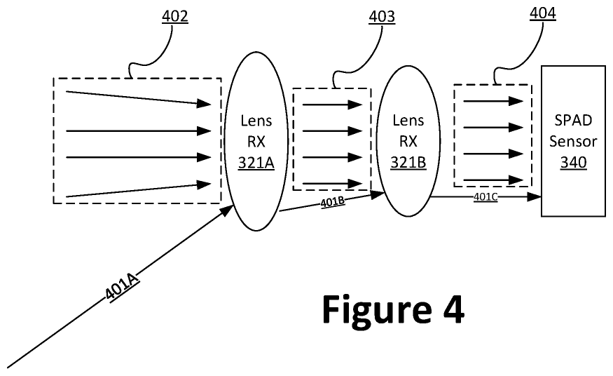

FIG. 4 provides a simplified diagram illustrating the undesirable glare that might be received and processed by LiDAR system 300. In this example, lenses 321A and 321B are components of lens 321, which may comprise multiple optical elements. The light signals 402 associated with an image are received by lens 321A (e.g., reflected from target 370), alongside undesired light 401A that contributes to glare. Light 401A could, for instance, originate from a potent light source (e.g., the sun) positioned outside the desired imaging region. As lights 402 transition through lens 321A, becoming light 403, the undesirable glare also passes through lens 321A. Similarly, as lights 404 reach the SPAD sensor 340, the glare 401C follows suit. It is to be noted that because light 401A enters lens 321 at an angle, it may be reflected multiple times (not illustrated in FIG. 4) before reaching SPAD sensor 340.

Now referring back to FIG. 3. While is not always possible to optically remove undesired optical artifacts such as glare 401C in FIG. 4, embodiments of the present invention provides various mechanisms for identifying and removing glare through signal processing techniques, as described above.

The SPAD sensor 340 converts the received laser signal into arrival signal pulses. In certain applications, a single SPAD pixel is sufficient for range determination, and a single TDC is implemented for that SPAD pixel. In various embodiments, the SPAD sensor 340 is implemented as a macro pixel, commonly referred to as a digital silicon photomultiplier (dSiPM). The TDC 350 consists of a number of TDCs (e.g., equal to the number of SPAD pixels) configured to process the arrival time of multiple pulses generated by the SPAD sensor 340. For instance, the TDCs in block 350 may be individually connected to their corresponding SPAD pixels in block 340 for efficient signal processing.

The output of the Time-to-Digital Converter (TDC) 350 is stored in memory utilizing a histogram data structure. This structure comprises memory blocks that correspond to predefined time intervals or ‘bins’, each block storing an intensity value—typically, the count of photons received within its associated time interval. This structure can account for instances of undesirable glare or undesired light bending, for example, from object 371, which might result in multiple peaks in the histogram data. Memory could incorporate devices like static random-access memory (SRAM), but it's adaptable to other types of memory devices as well. The Digital Signal Processor (DSP) 360, possibly integrated as a part of the control module 330, performs several functions, most notably identifying and mitigating glare and other undesired optical effects. Specifically, DSP 360 is configured to identify histogram peaks that correspond to glare or undesired optical effects and filter or remove these peaks to enhance data accuracy.

The described embodiments are provided for illustrative purposes only. Units described as separate components may or may not be physically separated, and components displayed as units may or may not be physical units; they can be located in one place or distributed across multiple network units. Some or all of the modules can be selected based on actual needs to achieve the purpose of the embodiment.

Through the descriptions of the above embodiments, those skilled in the art can clearly understand that the embodiments can be implemented using software in conjunction with a general hardware platform, or they can be realized through hardware. Based on this understanding, the essential aspects or contributions of the technical solutions can be embodied in the form of a software product, which can be stored in a computer-readable storage medium such as ROM/RAM, magnetic disk, optical disc, etc. The software product includes a set of instructions that enable a computer chip (which can be a personal computer, server, or network chip, etc.) to execute all or part of the methods of various embodiments.

In addition to others, conditional language such as “capable of,” “may,” “possibly,” or “can,” unless specifically stated otherwise or understood in the context in which they are used, generally conveys that a particular embodiment can include (but other embodiments do not include) specific features, elements, and/or operations. Therefore, such conditional language also generally implies that features, elements, and/or operations are required for one or more embodiments or that one or more embodiments must include logic for determining whether these features, elements, and/or operations are included or will be performed in any particular embodiment, with or without input or prompting.

The content presented in this specification, along with the accompanying illustrations, showcases examples of laser ranging methods and chips that effectively reduce glare. However, it's important to recognize that it's impossible to detail every conceivable combination of components and/or methodologies in the context of describing the numerous features offered by this disclosure. The potential permutations and combinations of the disclosed features are manifold. Therefore, it's clear that various adaptations can be made to this disclosure without straying from its essence or scope. Alternatively, in other embodiments, additional implementations of the disclosure may become evident upon examining the specifications, drawings, and practicing the disclosure as described herein. The examples provided in this specification and the accompanying illustrations should be regarded as illustrative in all respects rather than restrictive. While specific terminology has been utilized in this document, it is employed in a generic and descriptive sense, and not for purposes of limitation.

What is claimed is:

1. A lidar system comprising:
a laser source configured to generate a pulsed laser at a first time, the pulsed laser being characterized by a first pulse width;
an optical module configured receiving a reflected laser signal;
a pixel circuit configured to generate electrical outputs based on the reflected laser signal, the pixel circuit comprising m pixels;
a time-to-digital converter (TDC) configured to generate m histogram data corresponding to m pixels, each of the m histogram data comprising n intensity values corresponding to n time bins;
a memory device configured to store the histogram data; and
a processor module configured to:
generate a first data array comprising m values corresponding to the m pixels, each of the m values being a function of a sum corresponding n time bin values;
generate a second data array comprising m entries corresponding to the m pixels, each of m entries comprising one or more total peak values;
determine a first vector using the first data array;
determine a second vector using the second data array;
remove one or more artifact peaks from the second data array using a similarity function; and
determine a target object distance using at least the second data array.

2. The lidar system of claim 1, wherein the processor module is further configured to identify a preliminary peak location using at least the second data array.

3. The lidar system of claim 2, wherein the processor module is further configured to calculate a time of flight (TOF) value using the first time and a second time, the second time being based on the preliminary peak location.

4. The lidar system of claim 1, wherein the pixel circuit comprise a SPAD sensor array.

5. The lidar system of claim 1, the optical module comprises multiple lens elements, the one or more artifact peaks being associated with an internal reflection attributed to the multiple lens elements.

6. The lidar system of claim 1, wherein the one or more artifact peaks is associated with a glare caused by a secondary light source.

7. The lidar system of claim 1, wherein the one or more artifact peak is associated with a semitransparent object.

8. The lidar system of claim 1, wherein the processor module is further configured to calculate a Pearson correlation coefficient using at least the first data array and the second data array.

9. The lidar system of claim 8, wherein the one or more artifact peaks are associated with low similarity values.

10. A lidar system comprising:
a laser source configured to generate a pulsed laser at a first time, the pulsed laser being characterized by a first pulse width;
an optical module configured receiving a reflected laser signal;
a pixel circuit configured to generate electrical outputs based on the reflected laser signal, the pixel circuit comprising m pixels;
a time-to-digital converter (TDC) configured to generate m histogram data corresponding to m pixels, each of the m histogram data comprising n intensity values corresponding to n time bins;
a memory device configured to store the histogram data; and
a processor module configured to:
identify l histograms from the m histogram data, the l histograms comprising a first histogram and a second histogram;
identify a first peak from the first histogram at a first bin location;
identify a second peak from the second histogram at a second bin location corresponding to the first bin location;
calculate a ratio between a first intensity of the first peak and a second intensity of the second peak;
determine whether the second peak is an artifact peak based on the ratio;
determine a target object distance using at least the first peak.

11. The system of claim 10, wherein the artifact peak is associated with a glare caused by a secondary light source.

12. The system of claim 10, wherein the processor module is further configured to remove the second peak.

13. The system of claim 10, wherein the processor module is further configured to identify and remove a third peak.

14. The system of claim 10, wherein the first histogram is associated with a first SPAD pixel and the second histogram is associated with a second SPAD pixel.

15. A lidar system comprising:
a laser source configured to generate a pulsed laser at a first time, the pulsed laser being characterized by a first pulse width;
a control module configured to process the first time;
an optical module configured receiving a reflected laser signal;
a pixel circuit configured to generate electrical outputs based on the reflected laser signal, the pixel circuit comprising m pixels;
a time-to-digital converter (TDC) configured to generate m histogram data corresponding to m pixels, each of the m histogram data comprising n intensity values corresponding to n time bins;
a memory device configured to store the histogram data; and
a processor module configured to:
generate a first data array comprising m values corresponding to the m pixels, each of the m values being a function of a sum corresponding n time bin values;
generate a second data array comprising m entries corresponding to the m pixels, each of m entries comprising one or more total peak values;
determine a first vector using the first data array;
determine a second vector using the second data array;
identify a first peak from the second data array using a similarity function.

16. The system of claim 15, wherein the first peak is associated with a glare artifact.

17. The system of claim 15, further comprising an optical splitter configured to direct a portion of the pulsed laser to the control module.

18. The system of claim 15, wherein the processor module is further configured to calculate similarity coefficients using the similarity function.

19. The system of claim 15, wherein the processor module is further configured to calculate a second time based on a second peak being selected using at least the second data array.

20. The system of claim 19, wherein the processor module is further configured determine a distance based on a difference between the first time and the second time.
